(19) United States
(12) Patent Application Publication
(10) Pub. No.: US 2007/0250841 A1
(43) Pub. Date: Oct. 25, 2007

(54) Multi-modal interface

(75) Inventors: Francis J. Scahill, Ipswich (GB); Simon P. A. Ringland, Ipswich (GB); Timothy J. Twell, Ipswich (GB); Richard J. Evenden, Ipswich (GB); Richard M. Wiseman, Ipswich (GB)

Correspondence Address: NIXON & VANDERHYE, PC, 901 NORTH GLEBE ROAD, 11TH FLOOR, ARLINGTON, VA, 22203, US

(73) Assignee: BRITISH TELECOMMUNICATIONS public limited company, London (GB)

(21) Appl. No.: 11/808,651

(22) Filed: Jun. 12, 2007

Related U.S. Application Data
(62) Division of application No. 10/472,046, filed on Sep. 17, 2003.

(30) Foreign Application Priority Data
Mar. 30, 2001 (GB) 0108044.9
Mar. 28, 2002 (EP) 02252313.8

(51) Int. Cl. G06F 9/00

(52) U.S. Cl. 719/320

(57) ABSTRACT

A system for synchronizing application programs which together provide a multi-modal user interface, which comprises multiple application programs which provide the various interface of the multi-modal interface and which are in communication with a synchronization manager. Means are provided to detect status changes in the application programs and to communicate such status changes, in the form of data updates to the synchronization manager. The synchronization manager is operative to communicate such a data update to the application program in which the data update did not originate so that the application programs are synchronized.

### CROSS REFERENCE TO RELATED APPLICATIONS

This application is a divisional of U.S. patent application Ser. No. 10/472,046 filed Sep. 17, 2003 which was the national phase of PCT/GB02/01500 filed Apr. 2, 2002 and which claimed priority from GB Application No. 0108044.9 filed Mar. 30, 2001 and EP Application No. 02252313.8 filed Mar. 28, 2002, the disclosure of which priority applications is incorporated herein by reference.

### TECHNICAL FIELD

The invention relates generally to multi-modal man-machine interfaces and to systems providing or using such interfaces.

### BACKGROUND TO THE INVENTION

Multi-modal interfaces are known. A multi-modal interface is generally understood to be a man-machine interface in which there is either more than mode of input from the user(s) or more than one mode of output to the user(s). Examples of input modes are keyboard, mouse, pen, stylus or speech while output modes may include a visual display through a VDU or speech or unvoiced sound or tactile output through a Braille device. A typical multi-modal interface might use the combination of speech, keyboard and stylus as input modes, while using a visual display supplemented with audio output as output modes.

For simplicity, the term “voice interface” is typically used to refer to the combination of voice input and audio output, while “a visual interface” typically refers to the combination of a visual display for output with some combination of keyboard, stylus and/or mouse for input. In a multi-modal interface which combines a voice interface with a visual interface, the voice interface would be described as one mode while the visual interface would be a second mode.

A well designed multi-modal interface should allow the user to interact with a computer in an intuitive and fluid way, and this should lead to faster task performance with fewer errors. A unimodal interface has certain advantages and weaknesses: speech is a rapid way of inputting large amounts of information, although it is difficult to describe unambiguously the position of an object with the spoken word; a keyboard or mouse is highly accurate in this sense; audio output is the only realistic way of providing music or pronunciation dependent information, but can be a long-winded way of delivering lists of information, in which instance screens are the best approach. A multi-modal interface should therefore be able to capitalize on the advantages of each of the component unimodal interfaces.

An example multi-modal interface may be conceived as a WAP-enabled mobile telephone accessing a ticket booking application. The user navigates WML pages in the normal way to reach a (visual) list of performances displayed on a screen, then selects and books a particular performance orally by dialogue with a VoiceXML interpreter. An interface such as this can be considered “sequentially multi-modal” because only one mode is active at any given instant. The constituent unimodal interfaces are said to be “uncoordinated” because values entered at one interface are not transferred to the other.

WO 99/55049 (Northern Telecom Limited) describes a system for handling multi-modal information. A central service controller or server processes information received from various unimodal interface programs. The central service controller decides on an appropriate output for each interface and this may involve retrieving information from the internet. The multi-modal system is highly centralized, where the control logic and data retrieval are provided by the central service controller. Advantages of this approach, in which multi-modal capability, or modal sensitivity, is provided in the server rather than in the user's terminal are said to be that:

It enables advanced services to be offered to “thin” clients, i.e. user's terminals with limited physical processing and storage, which would be unable to support such advanced services locally;

It enables new capabilities to be added to services without having to distribute software such as plug-ins to user's browsers, which in turn unburdens the user from having to install the plug-in, avoids taking up storage space on the user's terminal and eliminates the need for a mechanism in the server for distributing the plug-ins;

It is easier to build services which can be used by a variety of different types of user terminals, because the server can choose how to adapt the manner in which it sends and receives information to or from the terminal. Otherwise the terminal would have to adapt the manner of the communication according to its capabilities, which is outside the control of the service designer;

It facilitates the deployment of experimental features without the risk of distributing potentially unreliable software which might have unforeseen consequences for the user terminals;

It enables services to be installed at a central location which may be more accessible to hubs of various communications networks and thus make it easier to transfer data, e.g. in higher volumes, at greater speed or between networks; and

It enables bandwidth between the user and the server to be used more efficiently when information from different sources and in different modes is filtered, integrated and redistributed in condensed form at the server.

However, the Nortel system is inflexible in that the user has no freedom to choose which mode of input to employ, while the service designer must be familiar with high level language of the central service controller dialogue if the system is to be modified, for instance to accommodate a new interface application program. It is a significant disadvantage that this means that the designer must consider simultaneously all the potential interactions of the modes, and design the application in a new multi-modal dialogue control language. As individual modes cannot be designed in isolation, the task becomes more complex. As the number of modes increases the complexity increases exponentially as one has to consider all of the interactions between each of the modes. We have appreciated that the approach to the provision of multi-modal interfaces set out in WO 99/55049 is non-optimum in many situations.

The Nortel system is limited in being integratable with clients for which the central dialogue controller already knows about the content type and is able to reformat presentation appropriately, by contrast systems according to the invention do not need to know about specific content types. All that is required is that the client application conforms to the data exchange protocol of the system according to the invention.

The Nortel system is limited in that content cannot be reused outside the multi-modal system since it relies on the central dialogue controller for flow control. By contrast, systems according to the invention allow content to be a complete standalone application which can be reused without modification outside the system according to the invention.

The Nortel system is limited in that the user interface is an exact equivalent in each mode. It does not allow a multimodal system where some responses can be unimodal only and some can be multimodal. Systems according to the invention use an application synchronization approach rather than a unified dialog model then content need not be equivalent and the equivalence need not be complete.

The Nortel system is limited in that dialogue flow control can not be independent for each mode, this removes the ability of the user to effectively perform two independent actions at once removing a potential efficiency improvement. In systems according to the invention independent flow control is allowed and hence this is possible. For example the user may respond orally to the current question from the IVR system but at the same time click on a checkbox unrelated to the current voice dialogue prompt.

The present invention seeks to provide an improved multi-modal interface. Preferred embodiments of the invention are particularly suited to applications in which a user terminal device is used to browse the internet or similar data network.

### SUMMARY OF THE INVENTION

In a first aspect the invention provides a system for synchronizing a group of application programs comprising;

synchronization manager software in communication with, via one or more communication links, a group of program applications, wherein each of the program applications is capable of communicating data with the synchronization manager and via the synchronization manager with other application programs in the group, wherein

the synchronization manager comprises application client and server components. The client component being either preinstalled in the application (or application platform) or being dynamically added to the application by the synchronization software. The client software component detects user interface related actions within the application and other relevant changes in the state of the application program and transmits these as data updates to the synchronization server software. The client also receives data updates from the server and makes them available to the application content, which may then result in a modification to the user interface. Independent connections are used for the send and receive to allow updates to be sent and received in parallel.

Each application program may also request information from the internet via the synchronization manager (for example by prefixing the URL of the information with the URL of the synchronization manager). Such requests are examined to see whether they are relevant to other application programs and if so data updates are sent to other application programs affected. This data update may include a request to other application programs to load new information from the internet, for instance requesting a page in a web browser type interface may force a page update in other web browser type interfaces in the group.

Each application program is also free to obtain information from the internet (typically HTML image files or voice grammar or prompt files) by use of an absolute URL addressing which bypasses the synchronization manager, this is advantageous in reducing load on the synchronization manager and improving responsiveness.

The synchronization manager of the present invention undertakes no control of the dialogues within individual application programs; it is a router and translator for information between application programs where each application undertakes its own dialogue according to its own content. Translation controls how application status changes are to be converted between different applications, in particular where the applications have different internal representations for the same logical data. It will be appreciated that it is the translation function which allows the unimodal interfaces to cooperate. Thus enabling the service designer to create multimodal user interfaces from potentially independently developed unimodal interfaces.

The synchronization software has the ability to introduce new application programs into the group of applications or to remove an existing application from the application group during a multimodal application This allows the system to adapt dynamically the interface in response to, for instance, user requirements, system requirements or conditions such as changes in network bandwidth.

In embodiments of the invention one or more of the application programs is a web browser.

In embodiments of the invention HTTP Requests are made by the client side component of the synchronization manager to transmit data updates to the server side components and HTTP Requests are made to retrieve data updates from the server side components of the synchronization manager.

Alternative protocols can be envisaged, these include industry standard protocols for example JAVA RMI, SOAP, SIP. But a proprietary TCP/IP protocol could also be implemented. Transporting data via the HTTP Request/Response mechanism is convenient in that it allows transport through corporate firewalls, which would block JAVA RMI, SIP or proprietary TCP/IP protocols.

The messages can be sent by a variety of means and a system may also employ a combination of such means. For example the voice browser may be behind the corporate firewall and hence JAVA RMI would be more efficient, whereas the HTML browser was outside the firewall and would need to use the HTTP mechanism.

Since each modality operates its own dialogue within its own application which may be on a client device or network resident server separate to the synchronization software then complex dialogue control is effectively distributed which reduces the load on the server. This has significant performance advantages over routing everything through a central service controller, the approach adopted in WO99/55049.

A further advantage of embodiments of the invention is that content developed for this architecture can be used on a single application program without the need for the synchronization server process at all. This degree of independence offers significant advantages for integration with unimodal legacy content. It also means that it is possible to test each mode independently and content can also be created independently for each mode and content creators are free to use their preferred content creation tools.

A further advantage of embodiments of the present invention is that some or all of the functionality of the synchronization server process can be transferred entirely to the client if necessary. For example a Web Browser application, a Voice Application and the synchronization manager may all reside on the client device or may be distributed across a combination of client and network devices.

In embodiments of the invention mapping means are provided for mapping data received from one application program into a form suitable for use by the other application programs of the group. This mapping means controls which dialogue (e.g. HTML or VoiceXML page) each application program should be working from and performs conversion between corresponding dialogue fields of each application program. To this end, preferred embodiments of the system uses an XML-based document (a “mapfile”) accessible by the synchronization server to describe these two types of mapping.

The content retrieved from the internet via the synchronization manager may be another map document which may be used to augment or replace the existing map file for the group.

In a second aspect the invention provides a system for synchronizing application programs which together provide a multi-modal user interface, the system comprising: i) first and second application programs, the first of which provides a first user interface of the multi-modal interface, and the second of which provides a second user interface of the multi-modal interface; ii) a synchronization manager; iii) communications links between the synchronization manager and each of the application programs by means of which the synchronization manager can communicate with the application programs;

iv) communications links between the synchronization manager and each of the application programs over which the application programs can transfer data to the synchronization manager; wherein means are provided to detect status changes in the first and second application programs, means being provided to communicate such status changes, in the form of data updates to the synchronization manager, the synchronization manager being operative to communicate such a data update to the application program in which the data update did not originate so that the first and second application programs are synchronized.

In a third aspect the invention provides a method for synchronizing application programs which together provide a multi-modal user interface, the multi-modal interface comprising a plurality of application programs, a first of which provides a first user interface of the multi-modal interface, and a second of which provides a second user interface of the multi-modal interface, and a synchronization manager which can communicate with the application programs, the synchronization manager comprising a client component for each of the first and second application programs and a server component, the client components being operative to detect user interface related actions in the application programs and changes in the state of the application programs and to transmit such detected actions and changes of state, in the form of data updates, to the server component, the server component being operative to communicate such data updates to the application programs; the method comprising: (i) detecting user interface related actions in the application programs; transmitting such detected actions, in the form of data updates, to the synchronization manager; converting, as necessary, under the control of the synchronization manager, the data updates into forms suitable for each of the other application programs, (iv) communicating the converted data updates from the synchronization manager to the application programs;

so that user interface related actions in respect of one application program are detected by the client component, and the relevant data from the detected actions are communicated by the server component to the other application programs to synchronize the application programs.

In a fourth aspect the invention provides a system for synchronizing application programs which together provide a multi-modal user interface, the system comprising: i) a plurality of application programs, a first of which provides a first user interface of the multi-modal interface, and a second of which provides an second user interface of the multi-modal interface; ii) a synchronization manager; iii) communications links between the synchronization manager and each of the application programs and the by means of which the synchronization manager can communicate with the application programs; iv) communications links between the synchronization manager and each of the application programs over which the application programs can transfer data to the synchronization manager; wherein the synchronization manager comprises a client component for each of the first and second application programs and a server component, the client components being operative to detect user interface related actions in the application programs and application generated events and to transmit such detected actions, in the form of data updates, to the server component, the server component being operative to communicate such data updates to the application programs, the arrangement being such that user interface related actions in respect of one application program are detected by a client component, and the relevant data from the detected actions are communicated by the server component to the other application programs so that the application programs are synchronized.

In a fifth aspect the invention provides a method for synchronizing application programs which together provide a multi-modal user interface, the multi-modal interface comprising first and second application programs, the first of which provides a first user interface of the multi-modal interface, and the second of which provides a second user interface of the multi-modal interface, a synchronization manager able to communicate with the application programs, the method comprising the steps of (i) detecting status changes in the first and second application; (ii) communicating such status changes, in the form of data updates to the synchronization manager; and (iii) transmitting from the synchronization manager such a data update to the application program in which the data update did not originate so that the first and second application programs are synchronized.

In a sixth aspect the present invention provides a system for the provision of a multi-modal user interface which has a first user interface part and a second user interface part, at least the first user interface part operating according to stored dialogues; and control means arranged to control the operation of the multi-modal interface and operatively connected to the first and second parts;

wherein the first part has, for at least some of the possible dialogues which it supports, multiple alternative versions of the dialogues, the system being configured to switch between dialogues and between the alternative versions of the dialogues in dependence upon conditions in the multi-modal user interface.

In a seventh aspect the invention provides a system for the provision of a multi-modal user interface which has a first user interface part and a second user interface part, at least the first user interface part including first means to provide cues to a user of the system according to stored dialogues and second means to receive input from the user; and

control means arranged to control the operation of the multi-modal interface and operatively connected to the first and second means;

wherein the first means has, for at least some of the possible dialogues which it supports, multiple alternative versions of the dialogues, the system being configured to switch between dialogues and between the alternative versions of the dialogues in dependence upon conditions in the multi-modal user interface.

Embodiments of the invention will now be described, by way of example only, with reference to the figures, where:

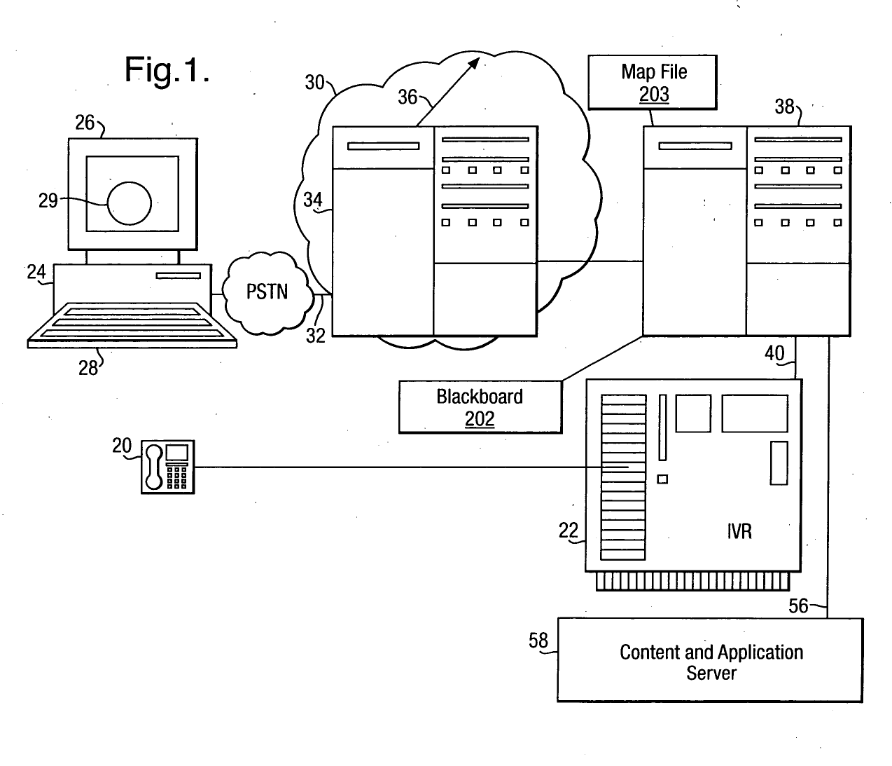

FIG. 1 is a schematic representation of a first embodiment of the invention;

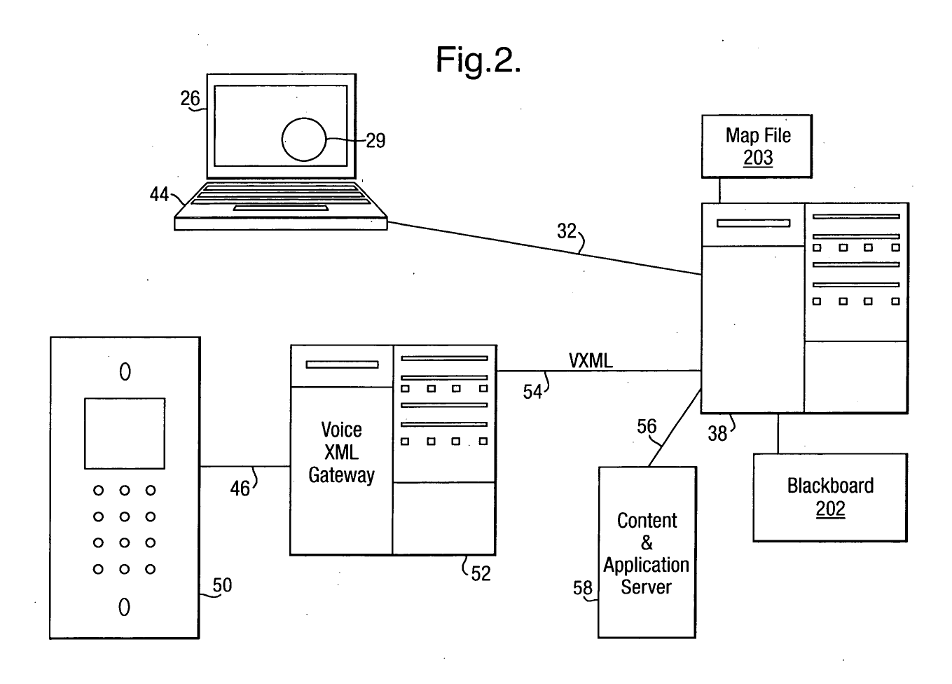

FIG. 2 is a schematic representation of a second embodiment of the invention;

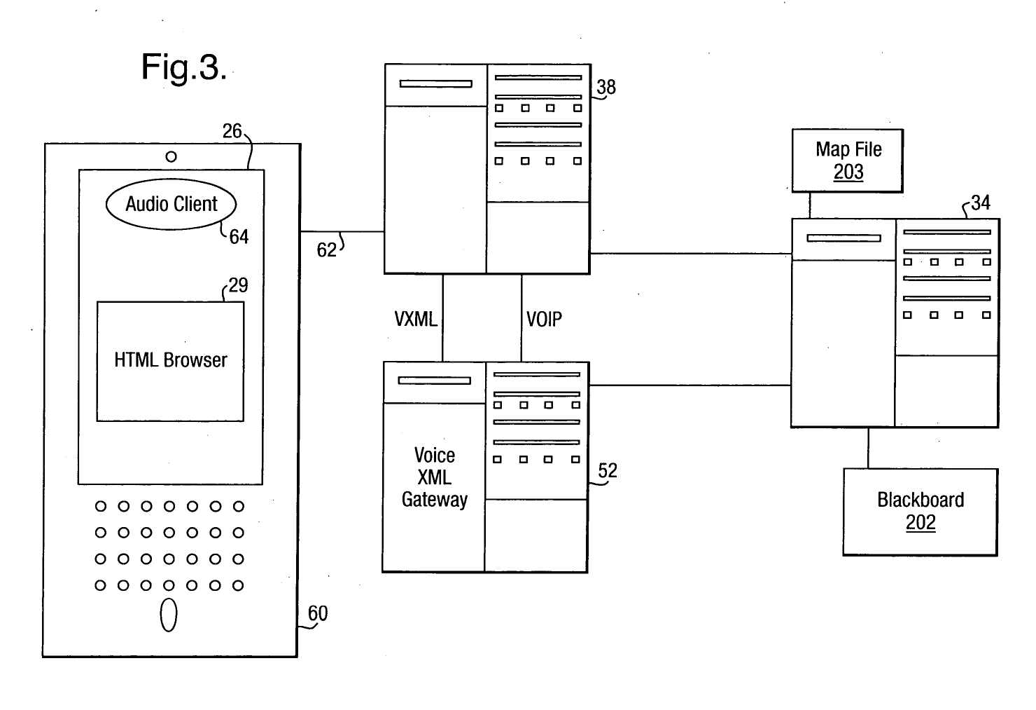

FIG. 3 is a schematic representation of a third embodiment of the invention;

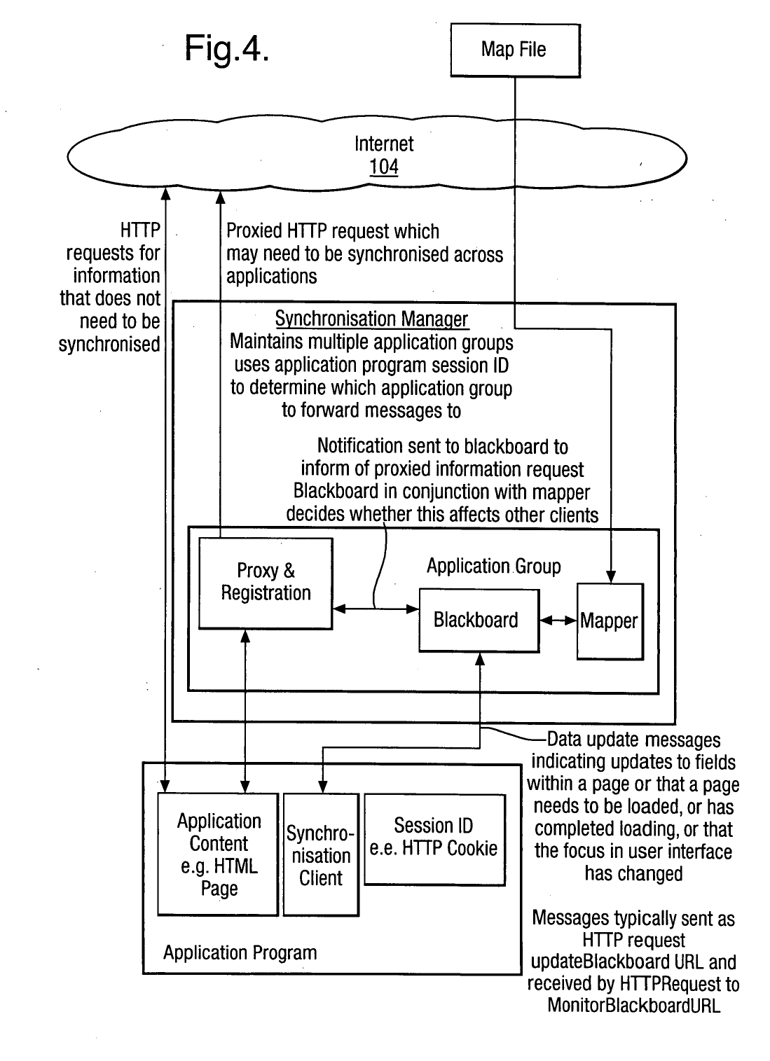

FIG. 4 is a schematic drawing showing the relationship between various of the more important elements of a system according to the invention;

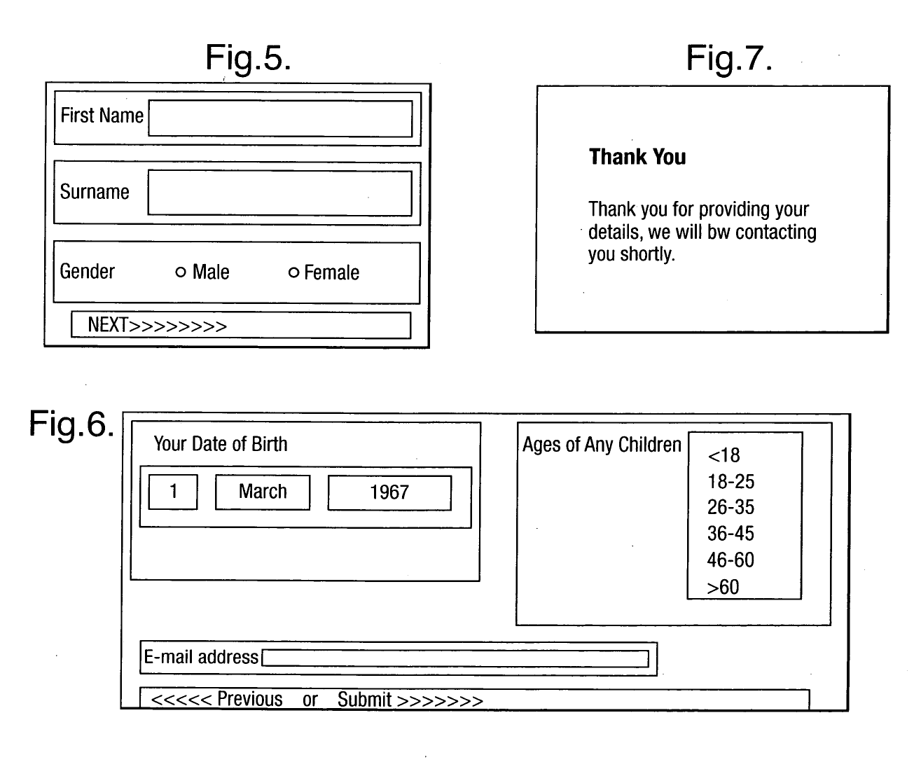

FIGS. 5,6 and 7 are representations of a sequence of pages of an application which uses the invention;

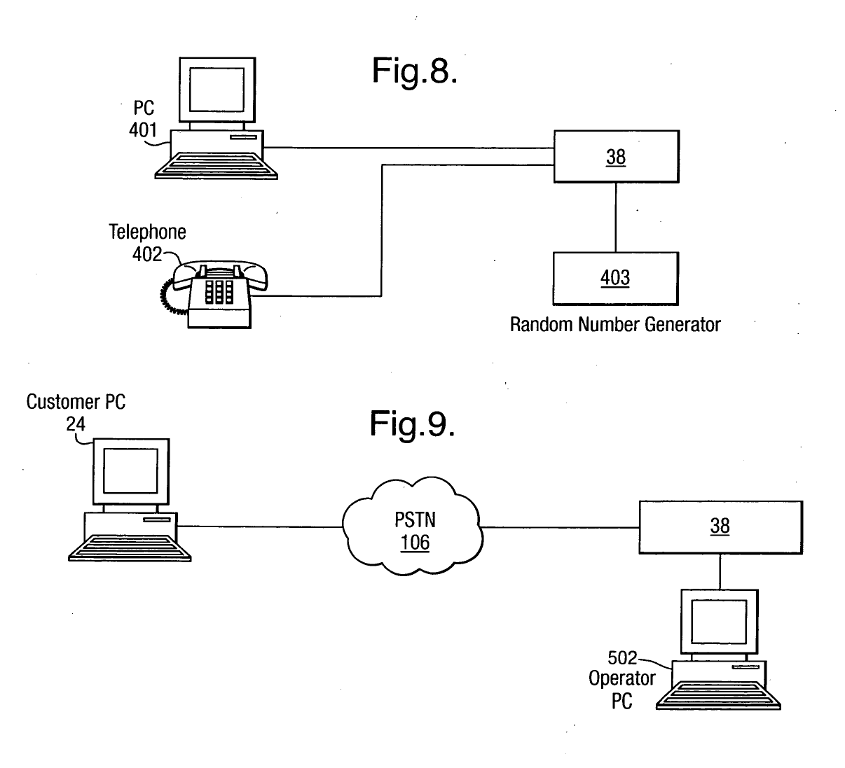

FIG. 8 is a schematic representation of an example of an implementation of the invention;

FIG. 9 is a schematic representation of a further example of an implementation of the invention;

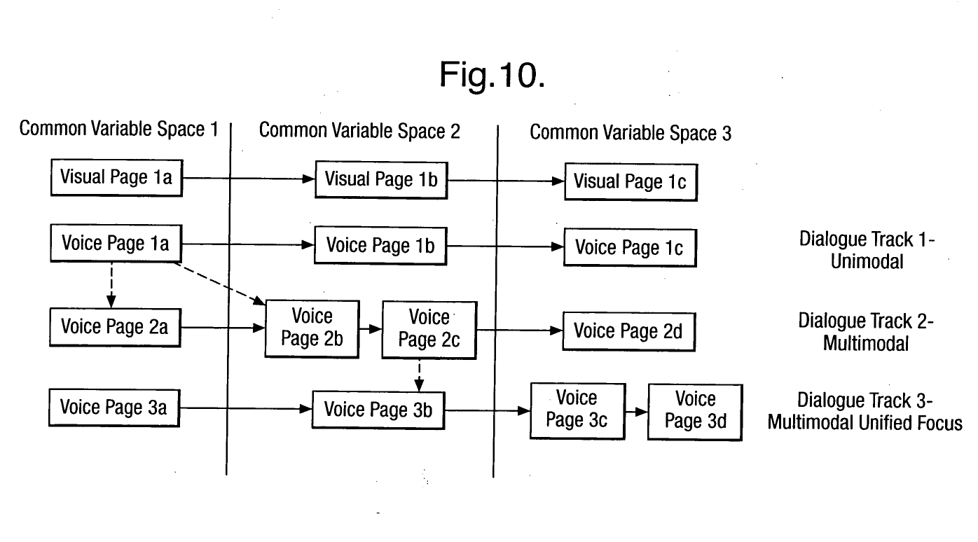

FIG. 10 shows how multiple voice dialogues may be used with a single visual track in systems according to the invention;

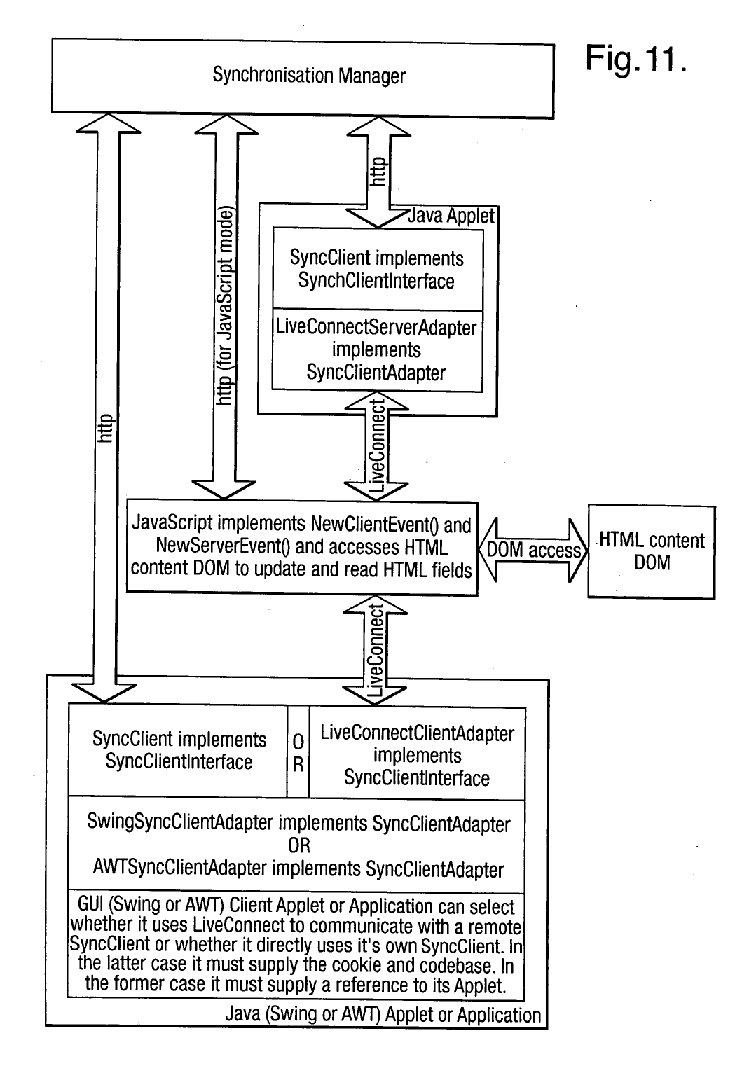

FIG. 11 shows schematically the architecture of a possible Java implementation of the client code for a system according to the invention; and

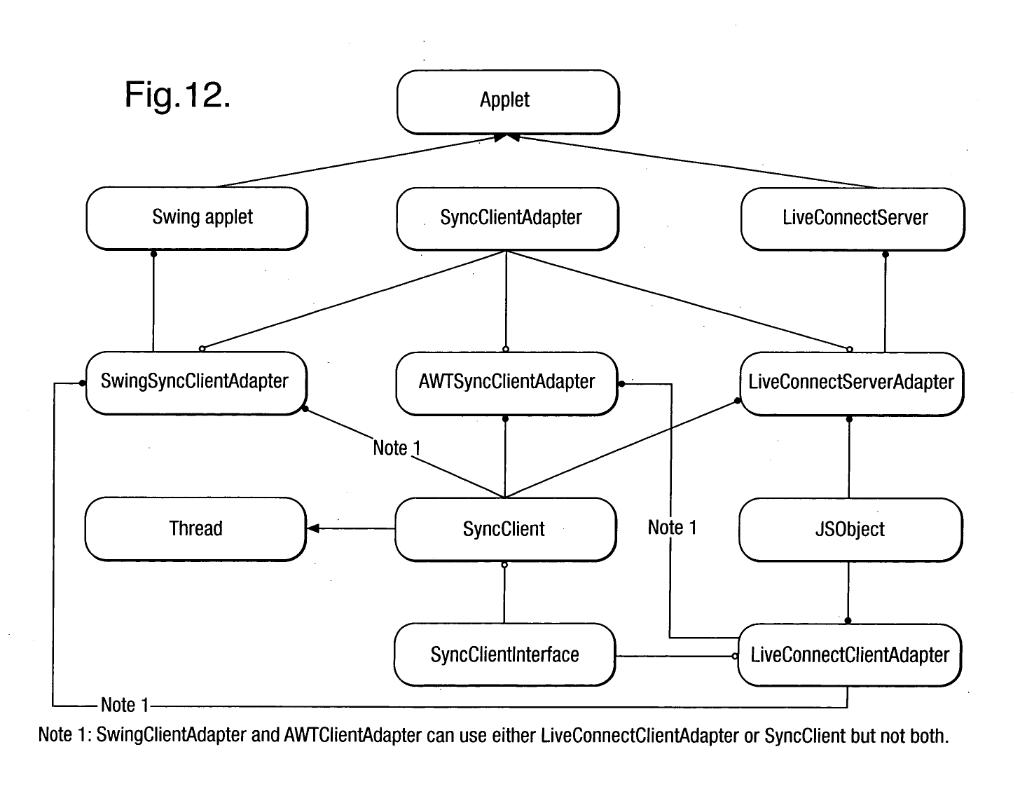

FIG. 12 shows a possible client class hierarchy suitable for use with the architecture shown in FIG. 11.

### SPECIFIC DESCRIPTION

### First Embodiment

FIG. 1 shows a basic system on which the invention has been implemented. The system includes a telephone 20 which is connected, in this case, over the public switched telephone network, PSTN, to a VoiceXML based interactive voice response unit (IVR) 22. The telephone 20 is co-located with a conventional computer 24 which includes a VDU 26 and a keyboard 28. The computer also includes a memory holding program code for an HTML web browser, such as Netscape or Microsoft's Internet Explorer, 29, and a modem or network card (neither shown) through which the computer can access the Internet (shown schematically as cloud 30) over communications link 32. The Internet 30 includes a server 34 which has a link 36 to other servers and computers in the Internet. Both the IVR unit 22 and the Internet server 34 are connected to a further server 38 which we will term a synchronization server. Note that IVR unit 22, Internet server 34 and synchronization server may reside on the same hardware server or may be distributed across different machines.

In the example shown a user has given a URL to the HTML browser, the process of which is running on the computer 24, to direct the browser 29 to the web-site of the user's bank. The user is interested in finding out what mortgage products are available, how they compare one with another and which one is most likely to meet his needs. All this information is theoretically available to the user using just the HTML browser 29, however, with such a uni-modal interface data entry can be quite time consuming. In addition, navigating around the bank's web-site and then navigating between the various layers of the mortgage section of the web-site can be particularly slow. It is also slow or difficult to jump between different options within the mortgage section. This is particularly true because mortgage products are introduced, modified and dropped fairly rapidly in response to changing market conditions and in particular in response to the offerings of competitors. So the web site may be subject to fairly frequent design changes, making familiarization more difficult. In order to improve the ease of use of the system there is provided a multi-modal interface through the provision of a dial-up IVR facility 22 which is linked to the web-site hosted by the server 34. The link between the IVR facility 22 and the server 34 is through the synchronization manager software 38

The web-site can function conventionally for use with a conventional graphical interface (such as that provided by Netscape or Explorer when run on a conventional personal computer and viewed through a conventional screen of reasonable size and good resolution). However, users are offered the additional IVR facility 22 so that they can have a multi-modal interface. The provision of such interfaces has been shown to improve the effectiveness and efficiency of an Internet site and so is a desirable adjunct to such a site.

The user begins a conventional Internet session by entering the URL of the web-site into the HTML browser 29. The welcome page of the web-site may initially offer the option of a multi-modal session, or this may only be offered after some security issues have been dealt with and when the user has moved from the welcome page to a secure page after some form of log-in.

In this example the web-site welcome page asks the user to activate a “button” on screen (by moving the cursor of the graphical user interface (GUI) on to the button and then “clicking” the relevant cursor control button on the pointing device or keyboard) if they wish to use the multi-model interface. Once this is done, a new page appears showing the relevant telephone number to dial and giving a PIN (e.g. 007362436) and/or control word (e.g. swordfish) which the user must speak when so prompted by the IVR system 22. The combination of the PIN or control word and the access telephone number will be unique to the particular Internet session in which the user is involved. The PIN or password may be set to expire within five or ten minutes of being issued. If the user delays setting up the multi-modal session to such an extent that the password has expired, then the user needs to re-click on the button to generate another password and/or PIN.

Alternatively this dialing information may included in the first content page rather than as a separate page.

Alternatively if the user was required to login to the website then the ‘click’ may result in the IVR system making an outbound call to the user at a pre-registered telephone number.

In addition the welcome page may include client side components of the synchronization manager which are responsible for detecting user interface changes (e.g., changes in form field focus or value) in the visual browser and transmitting these to the synchronization manager, as well as receiving messages from the synchronization manager which contain instructions on how to influence the user interface (e.g., moving to a particular form field, or changing a form field's value).

In addition when providing this page the synchronization manager provides the web browser with a session identifier which will be used in all subsequent messages between the synchronization manager and the web browser or client components downloaded or pre-installed on the web browser.

In the case where the user calls the IVR system, using the telephone 20, the user is required to enter, at the voice prompt, the relevant associated items of information which will generally be the user's name plus the PIN or password (if only one of these is issued) or to enter the PIN and password (if both are issued by the system) in which case entry of the user's name will be in general not be needed (but may still be used). Although the PIN, if used, could be entered using DTMF signaling, for example, it is preferred that entry of all the relevant items of information be achieved with the user's voice. The IVR system will typically offer confirmation of the entries made (e.g. by asking “did you say 007362436? Did you say swordfish?”), although this may not be necessary if the confidence of recognition of all the items is high. Once the IVR system has received the necessary data, plus confirmation, if required, it sends a call over the data link 40 to the synchronization manager 38 and provides the synchronization manager 38 with the PIN, password and/or user name as appropriate. The synchronization manager 38 then determines whether or not it has a record of a web session for which the data supplied by the IVR system are appropriate. If the synchronization manager 38 determines that the identification data are appropriate it sends a message to both the IVR system 22 informing it of the current voice dialogue to be run by the IVR and providing the IVR with a session identifier which is used by the IVR application when making subsequent information requests and data updates to the synchronization manager. The initial dialogue presented by the IVR system 22 may also provide voiced confirmation to the user that the attempt to open the multi-modal interface has been successful. Preferably the web server 38 also sends confirmation to the computer 24, typically via a new HTML page, which is displayed on screen 26, so that the user knows that the attempts to open the multi-modal interface has been successful.

At this point, either or both of the IVR system 22 and the web server 38 can be used to give the user options for further courses of action. In general it is more effective to give the user a visual display of the (main) options available, rather than the IVR system 22 providing a voiced output listing the options. This is because visual display makes possible a parallel or simultaneous display of all the relevant options and this is easier for a user (particularly one new to the system) to deal with than the serial listing of many options which a speech interface provides. However, an habituated user can be expected to know the option which it is desired to select. In this case, with a suitably configured IVR system, preferably with “barge in” (ie the ability for the system to understand and respond to user inputs spoken over the prompts which are voiced by the IVR system itself), and appropriately structured dialogues, the user can cut through many levels of dialogue or many layers (pages) of a visual display. So for example, the user may be given an open question as an initial prompt, such as “how can we help?” or “what products are you interested in?”. In this example an habituated user might respond to such a prompt with “fixed-rate, flexible mortgages”. The IVR system recognises the three items of information in this input and this forces the dialogue of the IVR system to change to the dialogue page which concerns fixed-rate flexible mortgages. The IVR system requests this new dialogue page via the synchronization server 38 using data link 40. Also, if the fact that the dialogue is at the particular new page does not already imply “fixed-rate, flexible mortgages” any additional information contained in that statement is also sent by the IVR system to the synchronization server 38 as part of the request.

The synchronization server 38 uses the session identifier to locate the application group that the requesting IVR application belongs to and using the mapping means converts the requested voice dialogue page to the appropriate HTML page to be displayed by the Web browser. A message is then sent to the Web Browser 29 instructing it to load the HTML page corresponding to Fixed rate mortgages from the webserver 34 via the synchronization manager 38 using data link 20. In this way both the voice browser and the web browser are kept in synchronization “displaying” the correct page.

The fixed rate mortgage visual and voice pages may include a form containing one or more input fields. For example drop down boxes, check boxes, radio buttons or voice menus, voice grammars or DTMF grammars. The voice browser and the visual browser execute their respective user interface as described by the HTML or VoiceXML page. In the case of the Visual browser this means the user may change the value of any of the input fields either by selecting from e.g. the drop down list or typing into a text box, for the voice browser the user is typically led sequentially through each input field in an order determined by the application developer, although it is also possible that the voice page is a mixed initiative page allowing the user to fill in input fields in any order.

The user selects an input field either explicitly e.g. by clicking in a text box or implicitly as in the case of the voice dialog stepping to the next input field according to the sequence determined by the application developer. Then the client code components of the Synchronization manager send messages to the synchronization manager indicating that the current ‘focus’ input field has changed. This may or may not cause the focus to be altered in the other browsers depending on the configuration of the synchronization manager. If the focus needs to change in another browser then a message is sent from the synchronization manager to the client component in the other browser to indicate that the focus should be changed. For example if the voice dialog asks the question “How much do you want to borrow” then the voice dialogue will indicate that the voice focus is currently on the capital amount field. If so configured then the synchronization manager will map this focus to the corresponding input element in the visual browser and will send a message to the visual browser to set the focus to the capital amount field within the HTML page, this may result in a visible change in the user interface, for example the background colour of the input element changing to indicate that this element now has focus. If the user then responds “80,000 pounds” to the voice dialogue then the input is detected by the client component resident in the voice browser and transmitted to the synchronization manager. The synchronization manager determines whether there is a corresponding input element in the HTML page, performs any conversion on the value (e.g. 80,000 pounds may correspond to index 3 of a drop down list of options 50,000 60,000 70,000 80,0000) and sends a message to the client component in the HTML browser instructing it to change the html input field appropriately. In parallel the user may also have clicked on the check box in the HTML page indicating that a repayment mortgage is preferred, this change in value of the input field is transmitted via the synchronization manager to the voice browser client components which modify the value of the voice dialog field corresponding to mortgage type such that the voice dialogue will now skip the question “Do you want a repayment mortgage?” since this has already been answered by the user through the HTML interface. Hence it can be seen that the combination of the client side components and the synchronization manager enable user inputs that affect the values of input elements of a form within an HTML or voiceXML page are kept in synchronization.

### Second Embodiment

FIG. 2 shows a second embodiment which may be considered to be a modification of the arrangement shown in FIG. 1. Here, a mobile phone 50 is in radio communication, over radio link 46, with a voice XML gateway 52. A VoiceXML-based browser is also provided on the gateway 52. The voice XML gateway communicates, using voice XML, over a data link 54 with synchronization server 38. A laptop computer 44 also communicates with the synchronization server 38, this time directly rather than via another server, over data link 32. An HTML-based browser 29 is provided on the laptop computer which is as usual provided with a screen, keyboard and pointer. The synchronization server 38 communicates over data link 56 with a content and application server 58. The contents and applications server 58 and the synchronization server 38 may both be processes running on a single processor or within a single computer.

The browsers are synchronized at the page level, such that requesting a new page using one type of browser causes the equivalent page, if it exists, to be pushed to the other browser in the group. Page level synchronization is achieved by having all requests for synchronized (i.e., mapped) pages made via the proxy, which uses the mapper and blackboard to instruct clients to load their corresponding page. This uses the same mechanism as when new form field values are pushed to the clients. The browsers are further synchronized at the event level such that data entered in a form element of one browser may be used to update any corresponding form elements in the other browser. In this way the browsers are kept current and the user may alternate between browsers according to personal preference.

Using the HTML browser the user starts a session by entering the URL to visit an application program's homepage.

The start-page for the chosen application is returned by the synchronization server 38.

At this point, the user decides to bring the voice browser into the session. He may do this by simply phoning up the voice browser, which recognizes his phone number (via CLI) and presents him with a list of groups he is permitted to join, from which he selects one (or if there's only one such group, perhaps joining him into that one straight away). The voice browser immediately goes to the VoiceXML page corresponding to the displayed HTML page. This happens because the server knows what page each client should be on, based upon the contents of the mapfile.

### Third Embodiment

A very simple example of an application which uses the invention is here described with reference to FIGS. 5, 6 and 7. The application is a gatherer of basic information. There are three visual pages: the first with fields for first name, surname and gender; the second with fields for e-mail address, age ranges of any children and date of birth; the third page displays a thank you message and has no data entry fields. When asked orally via the VoiceXML browser for his date of birth, the user chooses to speak that information and at the same time uses the mouse and keyboard to enter the age ranges of his children. The UpdateBlackboard servlet is called in rapid succession by the two browsers, in this case by the HTML browser first because it is quicker to click on a menu item than speak a date. As soon as the date is placed onto the blackboard 202, the HTML browser's waiting MonitorBlackboard servlet request is provided with the new information and the HTML form is updated. Every time the VoiceXML browser sends information to the blackboard 202, it is returned with updated information—so as the children's ages reached the blackboard 202 first, this information is returned to the VoiceXML browser when it supplies the date to the blackboard 202, and therefore there is no need for the VoiceXML browser to request children's ages from the user. The date is automatically entered into the HTML form, and the voice browser is informed of the children's age ranges.

The user is then orally prompted for his e-mail address, which he chooses to type.

The user is then asked whether he wants the information he has entered to be e-mailed to him, and rather than using the mouse to clear the checkbox on the HTML form he chooses to say “No.”—the checkbox is cleared automatically. The information is sent to the blackboard 202 via the UpdateBlackboard servlet and the HTML browser's waiting call on the MonitorBlackboard servlet is then informed of the new information, which is updated in the HTML form.

The voice browser no longer has any more information to collect, so asks the user whether the displayed information is correct. The user is free to go back and forth between the pages using the links as all the previously-entered information will be filled in automatically for each page. The user can either reply orally “Yes” or click the “Submit>>” link in the HTML browser. He opts to say “Yes” and the voice browser requests and loads its next page; this request causes the HTML browser to load its corresponding page. The voice browser requests a synchronized page i.e., one that is included in the map file 203 and the page is returned. The URL of the new page is placed onto the blackboard 202 and the appropriate page change information is passed to the HTML browser's waiting MonitorBlackboard call and the HTML browser loads the new page. The user can then exit the system by clicking the HTML browser's “Exit” button and hanging up on the voice browser. Each browser's session cookie is expired by the synchronization server 38 and static exit page is loaded.

### Third Embodiment

FIG. 3 shows a further embodiment of the invention. In this embodiment a smart phone 60 is in radio communication over data link 62 with synchronization server 38. The smart phone 60 includes an HTML browser 29 and an audio client 64. The audio client 64 communicates with a voice XML gateway 52 using voice over Internet protocol (VoIP) through the data link 62 and synchronization server 38. The VoIP connection is transparent to the IP bearer network so the smartphone situation utilizes whatever the IP bearer network is, be it a GPRS connection involving a air interface to a base station or whether it is a fixed IP connection with indeterminate number of IP routers between the audio client and the VoiceXML gateway.

### Fourth Embodiment

In a further embodiment of the present invention, a non VoiceXML call steering application is envisaged, in which a call steering dialogue is implemented using an interactive voice response system 22 employing an ordinary telephone 24 as an interface. The call steering application makes use of the explicit client component API calls to the synchronization manager to enable the call steering application to remotely control a web browser. By providing the synchronization server 38 as coordinating means, the user may track the progress of the call using an HTML browser on the computer 24 and may enter information at any stage of the process. The ability for application developers to make use of the synchronization manager in situations where the voice content is non voiceXML is advantageous in extending the complexity of the voice application possible and eases integration with legacy voice content.

### Fifth Embodiment

In a further example of an implementation of the present invention, shown in FIG. 9, a multimedia call centre is provided. In this example a call centre agent and at least one other user (although generically this applies to any multi user environment) are in a session with the same browser but presented with different content. Shown in the figure is the personal computer (PC) 24 of a customer who is accessing the call centre. The PC 24 is in communication with a server 38 via a public service telephone network (PSTN) 106, and an operator's computer PC 502. Both the customer PC 24 and the operator PC 502 run HTML browsers. The customer may invoke a multimodal session in the normal manner previously described, however in this situation it may be also be desirable for an operator to join her HTML browser into the application group to provide help and guidance to the user. In this situation it is advantageous for the HTML content displayed on the operator's browser to be different to that displayed on the customer browser, for example the operator display may include the customer details and transaction history. The synchronization manager enables, via the mapping means, the two different HTML views to be synchronized were appropriate though they remain different in content.

Embodiments of the present invention, for example as shown in FIGS. 1 to 3, involve a system which comprises a group of application programs in communication with a synchronization manager 38. It is the task of the synchronization manager 38 to synchronize the operation of the application programs currently running as a group such that individual application programs act co-operatively, each enjoying a certain degree of independence from the others in the group. Each of the application programs may be supported by a variety of hardware platforms, for instance an HTML web browser running on a personal computer (PC) 24, a WML browser running on a WAP enabled mobile telephone 50 or a voice browser using a telephone 20 as an interface.

When a voice browser is used it could be running more or less anywhere. It could be entirely on the client (e.g. PC 24, WAP phone 50 or smart phone or PDA 60), assuming that the client has enough processing power to perform speech recognition, or it could (and is more likely to be) networked somewhere else such as on the content and application server 58. In this latter case, the user could be speaking to it via a telephone 60, or audio client program 64 which transmits the audio using standard Voice-over-IP protocols, or a proprietary protocol which undertakes the speech recognition front-end processing before sending it for recognition to the network-based browser the latter being advantageous in distributed speech recognition systems as described in our international patent application WO01/33554 or a combination of the two e.g. VoIP for speech transmitted to client and recognition front end for audio sent to the server.

In preferred embodiments, the group of application programs may comprise any number or combination of application program types. Preferably the system is configured to permit an application program to join or leave the current group without having to close down and restart the system.

The user interface for each application program is dependent upon the hardware platform that is being used to run it; thus, different input and output modalities are supported by different platforms.

A dialogue between each application program and the user takes place via the user interface. It is also possible for an application program to require input from another application program, this input being received via the synchronization server 38.

Each of the application programs is connected to the synchronization server 38 by means of a communication link. The nature of the communication link between an application program and the synchronization server 38 is determined by the hardware supporting the application program. For instance, the communication link could be via a copper cable to connect a PC 24 to the synchronization server 38, or via a cellular radio network to connect a mobile telephone 50 or 60 to the synchronization server 38, or via the PSTN to connect a telephone 20 to the synchronization server 38.

The synchronization server 38 may also be connected to a further data source such as the internet, thus acting as a proxy server or portal, able to supply data such as web page content to any of the application programs should it be so requested. The synchronization server 38 is able to communicate, nominally by HTTP requests with at least one content and application server 58 (not shown in the diagrams) in order to retrieve content requested by the browsers. The content and application server process 58 can be anywhere on the internet that the synchronization server process 38 can “see”; it could be local, even part of the same machine. The synchronization server 38 is able to request pages and receive the requested pages from the content and application server 58 and is enabled to push pages to the HTML browser. Furthermore, each of the two browsers is able to directly request content from the content and application server 58. This reduces the computational load on the synchronization server 38. This of course assumes that the clients can “see” the content and application server 58, hence they can request pages directly from it rather than via the synchronization server.

Software for allowing an application program to communicate with the synchronization server 38 may either be provided already as a part of the application program or it may be downloaded from the synchronization server 38 when the application program joins a group.

As shown in FIG. 2, the system in the preferred embodiment comprises a synchronization server 38 in communication with the two browsers.

To deliver the multimodal capability the synchronization manager function may be broken down into a series of logical capabilities

Registration and session management—this involves the maintenance of the application groups and the management of membership of an application group

Dialogue state and blackboard—this involves the maintenance of the common variable space across applications within a group and the maintenance of the current dialogue for each of the application groups at any one time.

Media translation—this covers the conversion of variables in one application to the appropriate variables and values in another application. This also involves client side components for detecting user interface actions in the application and exchanging this data with other applications via the blackboard. These will be described in more detail in the following sections.

Registration and session management, for which the synchronization manager maintains two databases of information relating to the users and application groups which users may join.

The user database contains information such as user name, password, fixed/mobile telephone number, IP addresses of devices, SIP addresses etc. This database is populated either by a system administrator or by users themselves by sending a registration request to the synchronization manager, for example by completing and submitting an HTML form.

The synchronization manager also maintains a list of public application groups open to all users and private application groups that are available to specific users only, these groups may be static persistent groups set up by server configuration or by user request or dynamic groups created automatically by the server when the first application joins a group.

Each application group represents a potential multimodal user dialog.

There are a variety of ways in which an application may join a group, but these generally fall into two categories: 1) the application makes an unsolicited request to the synchronization manager to join a group; or 2) an application is invited into a group by the synchronization manager. In the former, typically the application does not know enough information to identify the group in one request and may have to undertake a series of request/responses with user interaction in order to identify the correct group. In the latter case the synchronization manager provides sufficient information in the invitation to identify the group.

Unsolicited requests to join a group are always user initiated. Invitations for a new application program to join the group may be sent at the request of the dialogue of another application program which is already a member of the group. In addition the synchronization manager may automatically decide that it is appropriate to bring another application program into the session. For example, the synchronization manager 38 might know from the mapfile 203 that it needs a particular type of browser to join the session (perhaps to display a street map or picture), and thus it sends an invitation accordingly.

In preferred embodiments of the systems according to the invention, invitations make use the Session Initiation Protocol (SIP) as the transport mechanism. The Session Initiation Protocol (SIP) is an application-layer control protocol for creating, modifying and terminating sessions with one or more participants. These sessions include Internet multimedia conferences, Internet telephone calls and multimedia distribution. Members in a session can communicate via multicast or via a mesh of unicast relations, or a combination of these. SIP invitations used to create sessions carry session descriptions which allow participants to agree on a set of compatible media types. SIP supports user mobility by proxying and redirecting requests to the user's current location. Users can register their current location. SIP is not tied to any particular conference control protocol. For details of SIP, see Internet Official Protocol Standards, Request For Comments No. 2543.

Upon receiving a request for an application program to join a group the synchronization manager will issue the new application program a unique ID (for example a unique session cookie) which the new application program will use when interacting with the synchronization server 38. In this way when the new application program sends notification of updates to the blackboard 202 and attempts to retrieve relevant data therefrom the synchronization manager is able to determine to which application group the application belongs and to pass these requests to the appropriate blackboard.

The behavior of joining groups will now be explained further with reference to examples.

A new application program may be requested by a user, for instance in the case where use of a laptop or PDA is required in addition to a mobile phone in order to display a map. The user may want a particular browser of theirs to join the group, so uses an appropriate mechanism to achieve that. For example the user may say the key phrase “show me” which causes the voice browser to request the synchronization manager to send an invitation to the visual client application for that user. The choice of visual client is determined by the synchronization manager consulting the user databases to determine the address of the visual client currently registered for the logged in user.

In this case the address of the PDA has been pre-registered with the synchronization manager, an invitation to join the group is sent to a client program on the PDA, for example a SIP User Agent, this invitation may be, for example, a SIP invitation. The invitation carries data which includes a URL generated by the synchronization manager which uniquely identifies the application group, for example a URL containing a GroupID parameter. The client program starts up the Web browser on the PDA with the URL provided in the invitation. The synchronization manager receives the request to join the application group and processes it in the normal way.

An alternative scenario involves a user, browsing a web site, who would like to use voice control. In this case the user may either dial a phone number displayed on screen, or alternatively click on a “CalIMe” button which would send a request to the synchronization manager asking it to instruct the voice browser to initiate either an ordinary telephone connection or a VoIP connection between the user and the IVR component. The telephone number to call or address of the VoIP audio client is determined by consulting the user database for the registered audio device of the user making the request for voice control.

If the user dials manually then if the IVR component receives a CLI (calling line identifier) which matches a known user then the IVR application will be joined into the application group for that user. If CLI is unavailable the IVR application may then conduct a dialogue aimed at identifying the user so that the application group may be found. Once the application group is identified the IVR application is joined in the normal way

Under the control of the server, applications may be exited from an application group, for example in the case of network congestion meaning that one mode is unreliable. This is achieved by the synchronization manager sending a request to the client application to load an Exit URL. In loading the exit URL the client is removed from the application group, and any session cookie in use is invalidated and the exit URL page removes the client side component of the synchronization manager from the client application. The user may explicitly request that a client application leave the application group by instructing the client application to load the exit URL itself. For example by clicking on an exit button in the visual interface or by voice command to the voice application e.g. “switch off voice control”.

Application programs may leave the group to the extent that all application programs can leave the group; for instance if there is a local power failure and the application programs are terminated, the application group itself may persist for a duration at the control of the synchronization manager or can be saved to a database (or similar) for future retrieval, so it is still available for use within the server. The session may be continued at a later time by applications reissuing the requests to join the application group, on rejoining the application group the applications are instructed to load the current dialogue as stored on the blackboard and any dialogue variables values are retrieved from the blackboard in the normal manner. Thus it can be seen that applications which exit a session may rejoin and continue without loss of application state.

Dialogue State & Blackboard

The synchronization manager 38 is provided with a “blackboard” 202, which is essentially a common repository of the data of all clients supported by the particular applications (in this case the IVR system 22 and the HTML browser 29). A separate blackboard is maintained for each application group. Whenever a form field on a particular client changes, that client sends the new information to the blackboard, which converts it as appropriate so it is in a form which can be displayed on the other clients and then pushes the new information to all other clients in the group. This is of course event level synchronization. The push is achievable through a variety of means, and can in particular be achieved by the client periodically requesting a list of updates. Since copies of all form fields for all supported client types are stored on the blackboard, if a client joins part-way into a session, any of its form fields for which values have already been supplied will be filled in from the blackboard. The blackboard 202 is in communication with the application programs (here the HTML browser 29 and the IVR system 22) and in communication with the server 38. The blackboard 202 acts as a forum whereby a change in state of any one of the application programs in a group is announced and the remaining application programs of the group may retrieve information concerning this change of state from the blackboard 202.

The blackboard 202 always holds a list of the information status of each of the application programs in the group. This information is always present in the blackboard which allows an application program to drop out of the group and re-enter a session later. The entire group may also to drop out of a session and pick up where it was left off at a later time. The blackboard 202 may also include information on the status of application programs which were not part of the initial group but which are in fact supported by the system, thus allowing an application program to join the group at a later stage. The “initial group” referred to here could be a subset of the clients that are allowed to join the session, so it is quite possible that other (allowed) clients will join the group later on.

Translation of Data Between Media Types Via Mapfile

The synchronization manager 38 and the blackboard 202 have access to a mapper 203. The map file is a table of instructions on how data entered in one application program may be converted into data which is suitable for use in the other application programs of the group. The map file will contain information such as, for example, algorithms which translate date fields between application programs, tables of equivalent URLs and more. In particular, the mapfile contains information on: (a) which browser types are handled by the mapfile; (b) input control, i.e., which browser types can change the page being viewed, which can provide form field values, and which can control the field that currently has focus (all these can be overridden on a per-page or per-field basis); (c) which form fields should be synchronized and how to convert between them; and (d) event handling. Each application program in a group will interact with the user (e.g. where the application is a voice browser or an IVR there will be a dialogue with the user) and the mapper 203 will translate the user inputs which allows the other application programs to be updated with the corresponding information.

The map file 203 comprises a look-up table which is used to map URLs between HTML and VXML browsers. When a browser requests a new page the map file is referred to by the synchronization server 38 to establish which other pages are required to update the other browser in the group. Conversion between pages need not be linear, in that a single page in one browser type may be equivalent to numerous pages for another browser type. The map file 203 further contains instructions on how page elements are to be mapped between browser types, for example date fields, quantities, addresses. It will be appreciated that it is the map file 203 which allows the unimodal interfaces to cooperate. Thus the service designer may create a dialogue for each of the component browsers and an appropriate map file 203, executed in XML, which translates messages between the browser types. It is beneficial that a service designer may construct this multi-modal interface using standard software editing techniques. The independence of each browser allows a user to select an appropriate input modality; restrictions imposed on the user during the session arise from the limitation of the dialogue of a particular unimodal interface and not through the relationship between unimodal interfaces.

Determination When and Whether to Update Clients

In order to determine whether a client needs to be sent updates, the blackboard makes use of the mapfile to determine which applications are affected by data updates received from an application. These applications will be sent the updates. In addition the synchronization manager maintains a version number for the application group's blackboard which is incremented on each update received from an application. In addition the synchronization manager records the blackboard version in an application specific data store when updates are sent to an application. Thus the synchronization manager knows which applications are out of date and require updates to be sent.

Client Side Components of the Synchronization Manager

In order to achieve synchronization between applications the synchronization manager needs to know of any user interactions within the individual applications and be able to send modifications to each application. To achieve this the synchronization manager makes use of client side components which integrate with the application content either automatically in the case of some applications such as HTML browsers or manually in the case of legacy voice applications. These client side components communicate with the synchronization manager through a messaging protocol. In one instance a protocol based on HTTP request/response is used since this is advantageous in enabling transfer of data through firewalls, alternative implementations of the messaging protocol are of course possible and include Java RMI, and the use of SIP Info messages or indeed any proprietary IP based protocol. In the following descriptions we provide explanations of the client side component implementation for various application types, these explanations cover how the client component is downloaded into the application and how it integrates with the application user interface. FIGS. 11 & 12 show the architecture of a possible Java implementation of the client code.

[This is just one class design which allows re-use of code between different client programs, for example all HTTP messaging is encapsulated in the SyncClient class for which there are adaptor classes depending on the type of client e.g., IVR platform, whether the client code is part of a standalone applet SwingClient or whether the client is used as part of an HTML browser LiveConnectClientAdaptor. The Perl API and the pure JavaScript clients are examples of alternative clients code which do not fit in the Java class hierarchy. This is one of the advantages of the architectures according to embodiments of the invention in that the server does not care which client is sending updates since all clients share the same message protocol, and the server does not need to know about the client application since it is not controlling the application it just needs to know how to send messages to the client, it is up to the client to act in response to the message.]

This architecture utilises a common class SyncClient to maintain the two communications links to the blackboard (update and monitor). Depending on the application type within which the client code is used will determine which of the SyncClientAdaptor classes is used to provide the integration between the messaging function provided by the SyncClient and the user inputs occurring in the application. Examples of the SyncClientAdaptors include a SwingSyncClientAdaptor for enabling Java Swing applets to be applications within a multimodal session, LiveConnectServerAdaptor to allow HTML browsers that support Java to be integrated in the multimodal session. A special case, the LiveConnectClientAdaptor, allows multiple applications to share a single SyncClient instance for messaging. Other adaptors not shown include ones for Java based VoiceXML browsers. It should be noted that this Java class structure is just one implementation of a client component for a system according to the invention, other implementations, including non-Java implementations, are of course possible.

Java Applet Approach

In a preferred embodiment of the invention, the HTML browser used supports Java applets. A single HTML document containing a frameset declaration and JavaScript is returned. The frameset comprises two frames: a main, content frame; and a smaller frame containing a Java applet and system control buttons, such as an exit button. The applet communicates with the synchronization manager's blackboard 202, informing it of user interactions with the HTML client, and receiving from it updates made by other clients. Updates are sent to the blackboard 202 by the client accessing a URL (the ‘update URL’) and passing parameters describing the update. Updates are retrieved from the blackboard 202 by the client accessing another URL, the ‘monitor URL’; the response to this request is sent by the blackboard 202 when updates are available, and as soon as the client receives any updates, it immediately re-requests the monitor URL.

The first page that is actually displayed in the content frame is a holding page with an animation to indicate that the system is working; the URL of the actual start page is placed onto the blackboard 202. When the monitor URL is first requested, the start page URL is immediately returned and is loaded through the proxy 202.

When a content page loads, it calls a JavaScript function in the frameset page that parses the content page to find all form fields; it modifies each field so that user interactions can be caught. A ‘document loaded’ event is sent to the synchronization manager to indicate that the client is ready to receive updates from other clients (via synchronization manager's monitor URL). Modification to the field actually means modification or (addition if the handler is not already defined) of the field.onchange( ), and field.onfocus( ) javascript handlers in each form field so that the client component side code is called by the normal HTML browser event mechanisms, which then ensures that the synchronization manager is notified of a change in value or focus. The normal html document level handlers are also modified document.onload and document.onunload to ensure the client component is notified when a page has loaded or is unloading. For some browsers, such as Internet Explorer and Netscape Navigator, these medications can be done by client side code since these browsers allow dynamic modification to the content. For other browsers e.g Pocket IE then the modification needs to be done by the server before it delivers the page to the browser, this is done by the server transcoding the content to add the client component function calls into the existing handler definitions.

The user fills in the form fields of the web page using the mouse (or other pointing device) and/or keyboard. When the user moves to a particular field in a form, a focus event is sent to the blackboard 202 to indicate that the particular field is active. This focus information can be sent out to other clients via the monitor URL so that each can focus on its corresponding element. When the user provides a value for an element, that is sent to the blackboard 202 and thence to other clients in the same way.

When the user clicks a link in the page, a request for the page is made to the synchronization manager 38. The synchronization manager 38 refers to the mapper 203. If the page is not in the map, content is returned only to the requesting browser since it cannot be synchronized. If the requested page is in the map, it is returned and the its URL and that of corresponding pages for other browser types are put onto the blackboard 202; these are then retrieved by any waiting calls on the monitor URL and each browser loads its appropriate page.

The system requires a minimum of modifications at the client side and any modifications are automatically provided by ECMAScript or a Java Applet from the web server. The user will not need to make any modifications. On some clients, pages that are to be synchronized are parsed and altered (to catch events as the user interacts), but that's all automatic as well. It may be necessary with Internet Explorer and some similar HTML browsers to get the user to change its caching policy (to check for new versions of documents every time they're loaded), but generally that is all that will be required. Unlike other approaches to multi-modal synchronization, where typically a special browser is required, it should be unnecessary to install new software on the various devices.

1/ JavaScript in Frames With Image Objects (Using the FIG. 1 Arrangement, for Example, But With a Less Capable Browser)

For browsers that do not support Java, an alternative embodiment of the HTML client's system of communication with the synchronization manager 38 uses a combination of hidden HTML frames and JavaScript Image objects.

The frameset returned to the client after logging in contains not two but three frames: content and controls frames as before, and an additional, minimally-sized ‘monitor frame’. Without Java, a Java applet cannot be used to send and receive information from the blackboard 202.

In this embodiment, sending is achieved using JavaScript Image objects, whereby an Image object is created and its content (ostensibly an image URL) is loaded from the update URL. This is permissible since the update URL's response can be ignored by the client; the Image object simply ends up representing an invalid image (since the content that is returned is not an image) and is discarded.

The content from the monitor URL does, however, have to be examined. The applet can use a plain-text representation of the updates, but JavaScript has no way of parsing such information. Instead, JavaScript (embedded in HTML) is returned that communicates the updates to the controlling JavaScript directly. Such a response must be loaded into a frame, and the hidden frame is used for this purpose; once the updates have been dealt with, a final piece of JavaScript causes the monitor frame to reload the monitor URL, ready for the next updates.

2/ JavaScript in Frames Without Image Objects (Using, for Example, the FIG. 1 Arrangement But With an Even Less Capable Browser)

Some browsers that do not support applets also do not support JavaScript's Image objects. In such cases, an alternative embodiment of the HTML client uses a similar approach for calling the update URL as is used in the non-Java case for calling the monitor URL. Instead of loading the response to the update URL into an image object, an additional hidden frame is employed and the update URL loaded there. This embodiment has the disadvantage that a rapid succession of updates being sent to the blackboard 202 may not all get through because one might stop the previous one from loading before it has managed to contact the blackboard 202. A further embodiment uses a simple queue to ensure that each update does not start before the previous one has completed; queued updates are, where possible, combined into a single call on the update URL.

3/ Java Swing Based Applet in a Multi-Modal Environment According to the Invention.

FIG. 8 shows a further example of an implementation of the present invention. In this example a game of roulette is provided to be played remotely. In this case the user has access to a personal computer (PC) 24 running an HTML browser, and a telephone providing a user interface to a VoiceXML browser. In this instance the user has chosen to play an on-line game of roulette using an HTML browser running on PC 24 and a VoiceXML browser, the interface to which is provided by telephone 20. A random number generator application 403 is also involved. The game itself takes the form of a Java applet which is loaded into the HTML browser from the synchronization server 38 when the user makes a request to start the game. An HTML page containing the Java applet is loaded into the browser running on the PC 24; the applet uses another, communications applet to communicate with the server, which means that it can send and receive data values from the blackboard (in the server 38). The VoiceXML browser (resident somewhere on the network, not in the server 38 as suggested by the diagram) joins the same group of which the HTML browser running the applet is a member. The user can use the mouse to drag chips onto the applet's roulette board, can speak the bet (e.g., “£20 on black”) or can click and speak (e.g., £38 here). When the user clicks the roulette wheel or says “spin the wheel”, the random number generator 403 is accessed by the synchronization server 38 (generally by means of an HTTP call, or via Java's RMI) to determine where the ball lands. The voice browser then announces whether or not the user has won anything, and the applet's view updates accordingly. The process of betting and spinning the wheel can then start again.

A Swing based Applet can be run in systems according to the invention by using the SwingSyncClientAdapter class. SwingSyncClientAdapter is an implementation of a client component interface that allows Java Swing Applets to communicate with the synchronization manager in a full duplex, multi-threaded mode.

Communication with the synchronization manager is in the form of events that can be sent and received via the normal HTTP request/response:

```
SET_FOCUS <component address>,
FOCUS_SET <component address >,
SET_VARIABLE <component address > <value>,
VARIABLE_SET <component address > <value>.
Where:  <value> is the value that the component is to hold or is
holding.
  <component address > is the address of a java.awt.Component
object in the form:
<url>#<applet name>#<component name>
Where:  <url> is the URL of the HTML document containing the
  Applet,
  <applet name> is the name of the Applet (i.e. the name attribute
  value).
  <component name> is a user defined string identifier for the
  component (defined when the user registers the object)
```

The FOCUS_SET event is sent from the Applet to synchronization manager (by the SwingSyncClientAdapter class) when a registered java.awt.Component is selected for focus.

The VARIABLE_SET event is sent from the Applet to the synchronization manager 38 (by the SwingSyncClientAdapter class) when a registered java.awt.Component value is changed.

The SET_FOCUS and SET_VARIABLE events are sent by the synchronization manager 38 to the Applet. The SwingSyncClientAdapter has a dedicated thread that listens for such events. When one of these events is received the SwingSyncClientAdapter class will look for a registered java.awt.Component with the specified component address. If a match is found the component has its focus or value set.

Automatic Receive and Send

The Swing Applet must register all java.awt.Component objects that are to automatically receive and send events. This is carried out through the function:
public void registerUIComponent(Component component, String componentName);
Where: component is an object derived from java.awt.Component.
   componentName is the user defined string identifier for the component (used in the component address).

Once registered the object will receive and send data updates automatically. For example to register a variety of java.awt.Component objects:

JTextField writeText = new JTextField(20);
JButton test1Button = new JButton(“Test Button 1”);
JMenuItem menuItem1 = new JMenuItem(“Menu item 1”);
JMenuItem menuItem2 = new JMenuItem(“Menu item 2”);
JRadioButton radioButton = new JRadioButton(“radio”);
JCheckBox checkBox = new JCheckBox(“check”);
JList dataList = new JList(data);
JTextArea textArea = new JTextArea(“Some example text”, 5, 3);
private SwingSyncClientAdaptor _client;
_client.registerUIComponent(write2Text, “write”);
_client.registerUIComponent(test1Button, “button”);
_client.registerUIComponent(menuItem1, “menuItem1”);
_client.registerUIComponent(menuItem2, “menuItem2”);
_client.registerUIComponent(radioButton, “radioButton”);
_client.registerUIComponent(checkBox, “checkBox”);
_client.registerUIComponent(dataList, “list”);
_client.registerUIComponent(textArea, “textArea”);

With the above examples focusing on any of the java.awt.Component objects will result in a FOCUS_SET events being automatically sent to the synchronization manager. Changing a value of the java.awt.Component object will send a VARIABLE_SET event. SET_FOCUS and SET_VARIABLE events from synchronization manager 38 are automatically handled by the SwingSyncClientAdapter class and the appropriate java.awt.Component automatically focussed or set.

Custom Receive and Send

It is also possible for the Applet to explicitly (i.e. non automatically) send and receive events to and from the synchronization manager 38. This is achieved by implementing an ActionListener interface that will handle events for a user defined action command

E.g. to receive events from the synchronization manager 38 with the component address “textBox”:

```
private SwingSyncClientAdaptor_client;
_client.setActionCommand(“textBox”);
_client.addActionListener(this);
...
public void actionPerformed(ActionEvent e) {
  Object component = e.getSource( );
  String action = e.getActionCommand( );
  if (action.equals(“textBox”)) {
    if ( component instanceof SyncEvent ) {
      String event = ((SyncEvent)component).toString( );
      writeText.setText(event);
    }
  }
}
```

To send a VARIABLE_SET event to the synchronization manager 38 with a component address of “textBox” and a value of “Hello World”:

VarEventData eventData = new VarEventData( );
eventData.put(“textBox”,_”Hello World”);
SyncEvent event = new SyncEvent(SyncEvent.SET_VARIABLE,
eventData);
_client.newClientEvent(event);
_client.forceSend( );

In a similar way to the Swing Applet described above, a Non User Interface Application or Applet could communicate with Synchronization manager 38. The Application would communicate with Synchronization manager 38 in a full duplex, multi-threaded mode as before. This design does not limit the implementation to Java.

A Non User Interface Application or Applet can register with Synchronization manager 38 in order to take part in a specified multi-modal session. It can implement Application logic that would allow the Application to control or listen to the other clients in a multi-modal session.

Voice Browser Interface

Since standard VoiceXML platforms has no equivalent of frames or applets, it is not possible to have a MonitorBlackboard servlet waiting continuously as with the HTML browser. Instead, the VoiceXML application content is modified such that a special field is added to each form which is executed once per iteration of the VoiceXML Form Interpretation Algorithm, this special field makes an HTTP request to the to the blackboard 202 to make sure it has the most up-to-date values of field variables and in response receives any outstanding updates from the blackboard: such a call is also made as soon as the page is loaded to ensure that any information already known is asked for.

VoiceXML has form fields it must fill, and to do this, it goes through them until it finds one it has not yet filled; it then tries to fill that in by interacting (in the manner specified in the VoiceXML) with the user. When that has been done, whether or not the field was successful filled, it goes back to the start and looks again for the first unfilled field. If it was unsuccessful at filling in a particular field, it will, in the absence of external influences like our system or embedded ECMAScript, try to fill that field again. This is the basis of the Form Interpretation Algorithm

Some VoiceXML platforms however provide extension APIs that enable integration of platform specific synchronization manager client code with the VoiceXML platform API. Typically this allows developers to define extensions to the VoiceXML language which invoke third party code. A further implementation of the voice browser interface makes use of these extension APIs to provide equivalent mechanisms to those used by the HTML Javascript/Java clients for detecting and transmitting/receiving updates from the blackboard. Unlike the previous example these extensions allow a separate threads of execution for the call to the MonitorBlackboard servlet thus enabling the voice interaction to interrupted during filling of a voiceXML field rather than waiting for the field to be collected before polling for updates from the blackboard.

In a further example implementation, the voice component of the system might be implemented using a traditional (non-voiceXML) voice platform. The IVR application would be written in the language native to the IVR, rather than in voiceXML. The interface between the IVR component and the synchronization manager is through the use of the normal HTTP message protocol accessed using an API implemented in, for example, Java or Perl. The API appears to the synchronization manager as if it is a normal HTML or Voice XML client. The API is invoked manually by the application designer at appropriate points in the application. For non-voiceXML IVR which does not have URLs to denote pages or state variables etc., as would be the case with Voice XML, dummy or pseudo URLs are entered into the mapfile to correspond to locations and variables etc. within the IVR Application. For example a LoadPage request for one of the pseudo URLs indicates to the synchronization manager that the voice dialogue has reached a certain state (although no actual page download is required). The synchronization manager then consults the mapfile to determine what synchronization actions are necessary, in the same manner as if the request had come from a normal client 9 such as an HTML or Voice XML browser.

Alternative Dialogue Styles

A further important aspect of the invention, which can be used in any of the preceding embodiment or with other multi-modal applications which differ from those previously described, is the provision of alternate implementations of the same voice dialogue within a multi-modal interface.

There are several reasons why within a multi-modal system one might want to choose dynamically between alternate implementations of the same voice dialogue. In particular there are several distinct situations in which the ability to use alternate voice dialog designs can give rise to significant benefits to the user and/or the system designer.

In a basic system of the invention the map file defines a static relationship between the different applications within the application group that make up the multi-modal user interface. The mapping between equivalent URLs or the mapping between input elements is only dependent on the application type being mapped to. However it is possible to extend this capability by allowing the mapping also to be conditional on the contents of the blackboard and/or knowledge of which applications are currently within the group.

The implementation description below shows one case where by making the URL mapping conditional on the these pieces of information one can implement different voice dialogues depending on which modalities (i.e. applications) are active. It also shows a case where the mapping of focus specifying events from the user (e.g. clicking in a text box) changes dependent on the value of a focus style system variable on the blackboard.

Unimodal vs Multi-Modal

A first situation where alternate voice dialogue types/contents can be beneficial is where the nominally the same voice dialogue is used both in conjunction with a visual mode and without an accompanying visual mode. In particular the voice dialogues may be different in terms of error handling, and/or the wording of prompts, for example if a visual display is available then the voice dialog may not bother to confirm each item in a form since the user can more easily read the information off the screen, similarly error correction may be more reliably performed by instructing the user to perform the correction in the visual mode rather than the voice mode.

This could apply equally well to the visual content, for example the visual interface may be designed with and without priming for the voice dialogue and the appropriate screen used according to whether the voice dialogue is available. Note that Priming for the voice dialogue is information presented visually which lets the user know what they are supposed to say to the voice interface. e.g. a screen indicator showing “Say yes or press the ‘Accept’ button” primes the user, letting them know that they may say “yes” at this point. This priming would be inappropriate if there is no voice mode, so an alternative visual track with the information “press the ‘Accept’ button” should be used in the unimodal case.)

Unified Focus vs Multiple Independent Focus

In a multi-modal system each mode has a focus mechanism. Focus is the active point of attention within an application. For example, in a graphical application which presents a form with a number of fields to be filled in, clicking with the mouse on a specific text box moves the “focus” to that text box, such that text entered through the keyboard is entered into that text box rather than any other one.

In a voice application where a dialogue aims to gather a number of pieces of information through a series of questions, the “voice focus” is the currently active portion of dialogue i.e. the question currently being asked.

For visual modes focus is provided explicitly by the user's mouse selection or tabbing through input elements. For a voice system focus is implicitly controlled by the sequence of dialogue nodes or explicitly controlled by a grammar with focus-specifying entries. As with the mouse specifying focus in the visual interface, it is possible to have a portion of dialogue (or an active recognition grammar) capable of specifying the “voice focus” (or indeed the visual focus). Note that this focus specifying grammar might be active in parallel with other information gathering grammars.

For example, in a voice form which is attempting to collect departure date and return date, a “focus specifying grammar” would contain two alternatives—“departure date” and “return date”. When this grammar is active, and the user says “departure date”, the voice dialogue will then be directed to the point in the dialogue which asks “where do you wish to depart from” and the corresponding information gathering grammar will be activated.

In a multiple focus system, each mode retains its own focus mechanism. This allows the user to answer multiple questions in parallel. In a unified focus system, focus is specified by one mode and the other modes are forced to that point in the interface. This restricts the user to providing one piece of information at a time, but offers the advantage that the user may find it more convenient to use one mode for specifying focus whilst using another to enter information. In certain circumstances specifying focus in a particular mode may be easy, while entering information in that mode might be difficult (or unreliable). e.g. it may be easy to specify focus on a text box with a stylus, but difficult to enter the information via the soft keyboard. Alternatively, in a noisy environment, the recognition might be reliable enough for the relatively simple task of focus selection (amongst a few alternatives), but the more complex task of information entry may be unreliable due to the noise. In this circumstance, it might be preferable to use the soft keyboard to enter the information.

Alternatively one mode may provide a more efficient interface for selecting focus (it may be quicker to say “destination” than move the cursor to the destination textbox and click).

This variability in focus mechanisms gives rise to different voice dialogues. In use the voice dialogs will be different since a unified focus mechanism implies that an explicit focus setting grammar be included in the voice dialog and that the voice dialog be able to cope with focus control provided from outside the voice dialog, hence the implicit flow within the voice dialog cannot be guaranteed to happen.

Architectural Implications & Modifications

Multiple Dialog Tracks

So from the examples just given it is desirable to be able to modify the dialogue dynamically during the course of the transaction with the user. In the synchronizing server system described earlier in this application, voice dialogues are conveniently described as a sequence of VoiceXML pages. These VoiceXML pages are mapped to corresponding visual pages in order to deliver the multi-modal user interface. Designing a voice dialogue that includes all the possible permutations depending on the different styles of interface is difficult and to capture this in a single testable sequence of voiceXML pages will be very difficult. Hence in preferred embodiments of the synchronizing server system each dialogue style is designed as a standalone dialogue which forms one track in the multi track system. FIG. 10 shows how this approach can be used.

In some systems according to the invention it is possible to allow both the specification of multiple voice dialog tracks and the mapping of these multiple dialog tracks to a visual dialog track. It should also be noted that visual pages may map to a sequence of voice pages in one dialog track and a single voice page in another dialog track. The key requirement then is to be able to switch between dialog tracks when certain conditions occur, for example the visual display disconnects then the system should switch from dialog track 2 or 3 to track 1.

Switching between dialog tracks may happen either at a boundary between voice pages or within a page itself. To achieve the seamless transition when switching within a page, it is necessary to maintain a common variable space across equivalent dialog pages in different dialog tracks. So when the voice dialogue is switched to the new page the variable space of the new page can be pre-filled from the common variable space.

Extensions to Mapping Description

In the systems described thus far, the relationship between the visual display and the voice dialogue is represented as a one-to-many mapping. Each visual page is mapped to the corresponding voice dialogue page or pages through the use of an <page-sync> XML element in the mapfile. In such systems the many to one mapping is designed to cope with the situation shown in dialog 2 or 3 of FIG. 10 where multiple voice pages correspond to a single visual page. The opposite too is possible where multiple visual pages correspond to a voice page.

For example to map an HTML document form.html to a VoiceXML document form.vxml a mapping entry as shown below is created.

```
<page-sync>
  <page type=”html”>form.html</page>
  <page type=”vxml”>form.vxml</page>
<page-sync>
```

This format does not address the issue of multiple dialog tracks mentioned above, because the same voice dialogue is used regardless of the user interface conditions such as which modes are actually in use or available or which focus mechanism is in use. In order to cope with the situations described above we introduce alternative many to one mappings between the voice dialogue and the visual page. The actual mapping selected is dependent on potentially a variety of factors including the two factors above e.g. modalities available and the focus policy in use.

```
<page-sync>
  <page type=”html”>visualpage1b.html</page>
  <alias type=”vxml” id=”b.vxml”>
    <track name=”dialog1”
cond=”uservariable1==independent&system.multi-modal==true”>
      <page> voicepage1b.vxml</page>
        </track>
    <track name=”dialog2” cond=”...”>
      <page>voicepage2b.vxml</page>
      <page>voicepage2c.vxml</page>
    </track>
    <track name=”dialog3” cond=”...”>
      <page>voicepage3b.vxml</page>
    </track>
  </alias>
<page-sync>
```

We add an <alias> element in the page-mapping XML. The alias element contains a list of dialog tracks, each dialog track containing one or more pages which may be delivered. The <track> element has both a name and a condition attributes. The condition attribute contains ECMAScript. The first track containing script that evaluates to true is used as the current active track, if none are true the first track is selected as the default. The ECMAscript has access to user defined variables specified within the mapping and generic system variables that describe such things as whether multiple modes are active, user preferences etc

The alias allows all pages to share the same element naming convention meaning that the conversion scripts which are applied when converting the values of the variables between visual and voice may be specified in terms of the element in the html document and the alias for the voicexml. The alias is effectively performing the grouping of the common variable space

Voice dialogue pages may use the alias as a URL to link between pages or may use the actual URL of their dialogue track. Resolution of an alias to the correct URL is performed by the synchronization server

In addition to specifying the conditions under which a certain dialog track should apply we also need to provide a mechanism for the user to modify the variables used within the track conditions according to events that occur during page rendering. A typical example of such an event is a focus specification received for instance when the mouse is clicked on a html input field. The <catch> element in the map file allows arbitrary ECMAScript processing to be associated with events. The events may be system events such as a focus change or mode change or user defined events generated by other handlers within the mapfile. The extension is to provide the <changetrack> element which allows the application developer to force the synchronization server to check for a track change.

```
<catch event=”focus”>
  <script>
    arbitrary ECMAscript processing
    set user defined variables
  </script>
  <changetrack/>
</catch>
```

Two modifications to the server processing algorithms are proposed here: the first is to change track on a transition between voice pages

This extension to the current architecture is that when a page request is received from the voice browser and that page request is part of an alias group then the actual page delivered is dependent on which of the page's conditions' attributes is matched. For a given browser type, alternative tracks are specified using a aliases. Which of the tracks within an aliased set is active is determined by a set of conditions which are evaluated. Each track has a conditional expression associated with it, which will evaluate to true or false. Each condition is evaluated in turn until the first track with condition that evaluates to true is found. This track is then chosen as the current active track, and the appropriate pages are delivered to the application.

So if a page from the unimodal dialog track is requested and the visual mode is now available then the corresponding page within the multi-modal dialog track is returned. If multiple conditions match then the first is selected.

The second modification is to enable the changing of track within a page. During an interaction with a user certain events may trigger the need to change dialog track, this could for instance be the addition of a new dialog mode, the receipt by the server of a focus-specifying event when the system is operating with a unified focus policy, or the user selecting a silent mode of operation where audio prompts are muted. In the case of focus-specifying events, these may cause transition to different dialog tracks depending on supplementary conditions such as whether the focus applies to a dialogue node not yet visited or one that has already been visited. The latter case this implies that the appropriate voice dialog to apply is the error correction dialog whereas in the former case the directed dialogue should apply.

Event handling in some embodiments of the invention is specified by the <catch> elements, the <catch> handler can catch system events such as focus setting, mode activation or user events thrown by <throw> elements within the mapfile. These event handlers can contain arbitrary ECMAscript which modify the user variables and if required invoke the system to attempt an immediate change of dialog track using the <changetrack> element. This causes the synchronization manager to re-evaluate the track conditions given the potential change in user or system variables, should the re-evaluation result in the current page for the voice browser being changed then the new page will be pushed to the voice browser. Effectively causing the voice dialog to switch styles.

Systems according to the invention achieve dialog track changes by effectively pushing the new page out to the voice browser by sending an instruction to the voice browser to load the page in the new dialog track. Since corresponding pages within dialog tracks share a common variable space then once the new page has been delivered the page variable space is refreshed from the common variable space which is held by the Blackboard under the control of the synchronization server. The variable space update may include a focus specification which identifies which dialog node in the current page is now in focus and hence where the voice dialog should begin within the page.

Dialogue Styles

The dialogue styles include but are not limited to:

1. Mixed Initiative Dialogue

The audio prompt is an open question soliciting potentially multiple pieces of information. The spoken response to the prompt is analysed for all the pieces of information supplied, and a further prompt is generated if more information is required. And so on. This subsequent prompts may be “open” or “directed” depending on what further information is required (e.g. if only one specific piece of information is required, a directed prompt might be used). Note that the response to the audio prompt might be by voice, through the GUI or a combination of the two. No control of the GUI focus is made as a result of any audio input. User selection of GUI focus has no effect on the audio dialogue.

2. Directed Voice Dialogue—No GUI Focus Control

The audio prompt is one of a series of directed questions each designed to elicit a specific piece of information (e.g. destination city, date, time). The series of prompts is designed to elicit all the required information. As above the response may be by voice, through the GUI or a combination of the two. If a piece of information is entered through the GUI prior to the corresponding audio prompt being played, then that audio prompt is skipped. User selection of GUI focus has no effect on the audio dialogue.

3. Directed Dialogue With GUI Focus Control

Same as above, except that as each audio prompt is played, the focus on the GUI is automatically moved to the corresponding point on the graphical interface. (e.g. when the audio prompt “Where do you wish to travel to?” is played, the cursor is moved into the “destination” entry box on the GUI.)

4. No Dialogue

Audio dialogue is suspended, with the possible exception of remaining sensitive to a wake-up command to reactivate the audio interface.

5. GUI Focus Led Dialogue—With Follow-Up Audio Prompts

As a focus selection is made on the GUI, the corresponding audio prompt is played. The user may then respond through either the graphical or audio interface. e.g. when the user clicks on the destination box on the GUI, an audio prompt “Where do you wish to travel to?” is played and the audio interface is set to accept the destination as a spoken response.

6. GUI Focus Led Dialogue—Without Follow-Up Audio Prompts

As above, except that no follow-up audio prompt is made after the focus selection. e.g. when the user clicks on the destination box on the GUI, the audio interface is set to accept the destination as a spoken response, but no prompt is played. The user may then enter the destination through either the graphical or audio interface.

7. Voice Focus Led Dialogue—With Follow-Up Audio Prompts

The voice interface is set to accept the names of the data entry fields. The user specifies by voice what piece of information they wish to enter next. The focus on the GUI is adjusted accordingly. A follow-up audio prompt then asks for the corresponding piece of information. The information may be entered by voice or through the GUI. (e.g. the user says “Destination” and the GUI focus is automatically moved to the destination box. An audio prompt “Where do you wish to travel to?” is played and the audio interface is set to accept the destination as a spoken response (in addition to the field names). The user may then enter the destination by voice or through the GUI.)

8. Voice Focus Led Dialogue—Without Follow-Up Audio Prompts

The user specifies by voice what piece of information they wish to enter next. The focus on the GUI is adjusted accordingly. No follow-up audio prompt is made. The information may be entered by voice or through the GUI.

9. No Audio Input

Audio input is suspended, with the possible exception of remaining sensitive to a wake-up command to reactivate the audio interface. (Modification of 1,3,5,6,7,8)

10. No Audio Output

Audio output is suspended. (Modification of 1,3,6,8)

11. Mixed Initiative Plus Voice Focus

Combination of 1 with 7 or 8. Adds the ability to set the focus on the GUI to a mixed initiative dialogue system

12. Audio Help

Switch to a dialogue with no voice input but voice output which provides help on the visual interface.

13. Image Free GUI

The GUI drops back to being text only—no images. (Can be combined with other styles)

14. One Item Per Page GUI

Instead of a GUI page requesting multiple pieces of information, switch to a mode where there are a sequence of pages where only one item of information is requested on the each page. (Can be combined with other styles) For each element of information input, its source (e.g. voice or GUI) is stored, together with a confidence measure for the correctness of the information (e.g. the confidence measure from the speech recognizer for a particular response). As well as changes in dialogue structure, prompts, speech recognition grammars, and interaction between voice and visual interfaces, the speech recognizer timeouts are adjusted dependent on the dialogue style.

Dialogue Style Selection Methods

Which dialogue style is in use at any particular time, for a particular user, is selected in dependence on one or more of the following:
a) Previously stored user preference
b) Explicit user selection through the visual interfaceExplicit user selection through the audio interface
c) Automatic selection based on content of user response e.g. default is mixed initiative and switches to focus based or directed if the spoken user response contains a focus specifier e.g. default is mixed initiative and switches to directed based on user response containing response to a single field, e.g. default is directed and switches to mixed initiative if response contains more than one data element
d) Automatic selection based on the user environment or location, e.g. if location information indicates they are on a train, the dialogue state might be switched to disable audio input (to stop false triggering on background noise).
e) Automatic selection based on SNR of the audio signal, e.g. if the SNR measured on the audio signal drops below a pre-determined threshold, then the audio input is disabled (9).
f) Automatic selection based on speech recognition confidence levels, e.g. if the confidence level from the speech recognizer is consistently below a pre-defined threshold in a mixed initiative dialogue (1), then the dialogue mode could be switched to directed (2) or (3) which would have easier speech recognition. If the confidence level persisted in being low, then the audio input could be disabled (9).
g) Automatic selection based on the error rate of the speech recognition Measure the error rate of the speech input by noting alterations via the GUI, or confirmation failures on the voice interface. If the error rate rises above a predefined threshold, then move from mixed initiative (1) to directed (2) or (3), or from directed (2) or (3) to disabled audio input (9).
h) Automatic selection based on transmission error rates for the various channels
i) Automatic selection based on the combination of devices used in the user interface. e.g.
j) Error Correction:
   If a confirmation request receives a negative response, the system automatically switches to:
   (i) a GUI focus led error correction dialogue (5) or (6)
   or
   (ii) a voice focus led error correction dialogue (7) or (8), with a prompt asking which field to correct next (or all correct).
   or
   (iii) a directed voice dialogue (2) or (3) where the order of information requests is based on the confidence level associated with the existing response, least confident first
      Additional Features
Visual Echo of Audio Prompt
   Have a portion of the GUI area reserved for displaying a textual representation of the current audio prompt. (Can be combined with other styles)
% Filled Status Bar
   For transactions which require multiple pages of GUI entry, a % filled status bar shows how far through the transaction you are at any point
Audio control of GUI features
   The audio interface is set up to allow commands modifying features of the GUI e.g. “Increase font size”, “Decrease font size”, “Remove images”, “Restore images”, “Page up” “Page Down”, “Scroll Right” “Scroll Left”, “One item per page”, “Restore default GUI”, “Disable GUI input”, “Blank screen”. (Can be active in parallel with other styles)
      GUI control of audio features. e.g. speaker mute, microphone mute, selection of dialogue style, speaker volume, microphone volume
      Application Content Modification

In one instance the synchronization manager can detect user interface events (e.g. clicking on a hypertext link) that result in fetching of resources from the internet by acting as a proxy. In order to achieve this proxying without requiring the user to modify the configuration of the host device for the application, the synchronization manager modifies the application content that it proxies to ensure that future requests are directed via the Synchronization manager. This is achieved for example by modifying URLs associated with Hypertext links such that they are prefixed with a URL that directs the fetch via the synchronization manager. In a preferred embodiment of the system the Synchronization manager performs this URL modification with reference to the mapfile such that only URLs that need to be synchronized are modified (thereby reducing load on the synchronization manager). In this way only the first request from the client need be explicitly sent to the Synchronization manager and this can be conveniently the initial join request from the client to the application group. This mechanism is automatic and hence does not require modification of the original application content.

In order for the application to synchronize user interface actions that do not result in a fetch of a resource from the internet then the application needs to invoke the client code at appropriate points. In the case of certain browsers this is achieved by the client code modifying the application content automatically, for example in the case of certain HTML browsers the client code locates all input elements within the HTML and modifies their existing onchange and onFocus handlers to invoke appropriate methods in the client API. For other browsers the modification needs to be made by the synchronization manager as content is proxied. So for example in the voiceXML case the Synchronization manager inserts additional XML tags at appropriate points (in the voicexml case this means one tag at the start of a page, and a tag in each <filled> element) in the VoiceXML document in order to invoke the client API on user input. Again it is advantageous for the synchronization manager to perform this translation with reference to the mapfile to reduce unnecessary load on the synchronization manager.

Of course both types of modification may be done offline by a service creation tool as well as online by the Synchronization manager.

Another example where synchronization could be of value, and hence where the invention could be applied is in synchronizing WML and HTML (for example in using a WAP phone to control an HTML browser in a shop window, so the HTML browser is effectively improving the graphical capabilities of the WAP phone). Another use case is synchronizing two voice browsers, each in a different language, so that two people of different nationalities could work together to complete a form. A further example is the synchronization of a voice interface (e.g. a voice browser) with a tactile (or haptic) interface such as a Braille terminal, so that a blind person can benefit from multi-modality, much as a sighted person does when using visual and audio interfaces.

What is claimed is:

1. A system for the provision of a multi-modal user interface which has a first user interface part and a second user interface part, at least the first user interface part operating according to stored dialogues; and
control means arranged to control the operation of the multi-modal interface and operatively connected to the first and second parts;
wherein the first part has, for at least some of the possible dialogues which it supports, multiple alternative versions of the dialogues, the system being configured to switch between dialogues and between the alternative versions of the dialogues in dependence upon conditions in the multi-modal user interface.

2. A system as claimed in claim 1, wherein the second user interface part operates according to stored dialogues; wherein the second user interface part has, for at least some of the possible dialogues which it supports, multiple alternative versions of the dialogues, the system being configured to switch between dialogues and between the alternative versions of the dialogues in dependence upon conditions in the multi-modal user interface.

3. A system for the provision of a multi-modal user interface which has a first user interface part and a second user interface part, at least the first user interface part including first means to provide cues to a user of the system according to stored dialogues and second means to receive input from the user; and
control means arranged to control the operation of the multi-modal interface and operatively connected to the first and second means;
wherein the first means has, for at least some of the possible dialogues which it supports, multiple alternative versions of the dialogues, the system being configured to switch between dialogues and between the alternative versions of the dialogues in dependence upon conditions in the multi-modal user interface.

4. A system as claimed in claim 3, wherein the second user interface part includes third means to provide prompts to a user of the system according to stored dialogues and fourth means to receive input from the user; wherein the third means has, for at least some of the possible dialogues which it supports, multiple alternative versions of the dialogues, the system being configured to switch between dialogues and between the alternative versions of the dialogues in dependence upon conditions in the multi-modal user interface.

5. A system as claimed in claim 1, wherein the first user interface part provides a visual user interface and wherein the second user interface part is an audio interface.

6. A system as claimed in claim 1, wherein the conditions in the multi-modal user interface to which can cause switching between dialogues and/or tracks in a dialogue include:
user input;
user preferences;
the presence or absence of additional modes of the multi-modal user interface; and
system state.
